(19) United States
(12) Patent Application Publication
(10) Pub. No.: US 2017/0191833 A1
(43) Pub. Date: Jul. 6, 2017

(54) Orienteering Tool Integrated with Flashlight

(71) Applicant: Fogo Digital Inc., Highland, UT (US)

(72) Inventors: Dustin Bouch, Petaluma, CA (US); Tyler Gilbert, Draper, UT (US); Larry Larson, III, Anaheim Hills, CA (US)

(21) Appl. No.: 14/986,446

(22) Filed: Dec. 31, 2015

(51) Int. Cl. G01C 21/00

(52) U.S. Cl. CPC G01C 21/00

(57) ABSTRACT

A GPS unit may be linked to an illumination devise so as to provide a seamless indication of directional movement in comparison to a desired course. The orienteering tool may have input means so as to program in a desired course, including keys, touch screen, or an external input connected through other means such as a USB port. A memory may be connected to a processor and may contain basic cartographic data or more. Other useful tools may be integrated into the tool for further increased utility.

### FIELD OF THE INVENTION

The present invention relates to the field of navigational aids and more particularly relates to an orienteering tool which detects and then communicates information about directional movement through an environmental illumination device, such as a flashlight.

### BACKGROUND OF THE INVENTION

Modern technology has advanced many areas of our lives. The advent of smartphones has placed what seems innumerable individual functionalities in one handheld unit. A smartphone serves not only as an access point for the Internet, but also functions as a camera, compass, flashlight, and directional aid. However, such functionality tends to be tied to the smartphone's connection to a service provider. It may also be difficult to maneuver a smartphone when orienteering at night or in other low light circumstances. Using the smartphone as both a flashlight and as an orienteering tool in these circumstances tends to expose the user to the bright smartphone screen while also attempting to illuminate the surrounding area. This creates a situation where the user's eyes are not well adjusted to the surroundings. Use of a smartphone may also distract a user from the surrounding environment as the user may concentrate on the screen and miss an obstacle, such as a rock, tree, or worse. Such an arrangement is also cumbersome to accomplish.

The present invention is a combination tool which includes and environmental lighting device, GPS tracking module and compass to create a simple orienteering tool which is usable in low light and dark circumstances and will not distract the user from the surrounding environment. Simple modifications allow use in fully light circumstances as well. Other tools, such as radios, two-way radios, and memory storage, may also be added to increase functionality.

The present invention represents a departure from the prior art in that the flashlight with directional indication of the present invention allows for a single tool which is capable of easy use in low light circumstances and clearly indicates variance from an intended direction of travel.

### SUMMARY OF THE INVENTION

In view of the foregoing disadvantages inherent in the known types of orienteering aids, this invention provides a combination tool which will aid in orienteering without distracting a user from the surrounding environment. As such, the present invention's general purpose is to provide a new and improved orienteering tool that is compact, intuitive to use and utilizes at least one other tool in the combination, such as a flashlight, to provide directional cues.

To accomplish these objectives, the tool comprises a GPS sensor and compass operatively connected to a processor. The processor is also operatively connected with an output light and means for input. In use, then, a user will input desired destination while the tool will calculate current position. Then, as the user travels to the destination, with the output light as a flashlight or through some other means, the processor will generate a pattern for light activation which will indicate to the user any deviation from desired direction. Other tools may be integrated into the system. Memory may be provided as well as a database of roads and trails, so that the processor may calculate position on a given route and indicate direction based on the route, not necessarily on a straight line distance. Radios may also be provided, as may any useful tool or component.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of an exemplary orienteering tool embodying the present invention.

FIG. 2 is a top plan view of a casing for the orienteering tool of FIG. 1.

FIG. 3 is a side elevation of the casing of FIG. 2.

FIG. 4 is a front elevation of the casing of FIG. 2.

FIG. 5 is a rear elevation of the casing of FIG. 2.

FIG. 5 is a rear elevation of the casing of FIG. 2.

FIG. 6 is a rear elevation of the casing of FIG. 2, with the end cap removed.

FIG. 7 is a schematic diagram depicting one phase of an embodiment of the methodology for orienteering with the orienteering tool of FIG. 1.

FIG. 8 is a schematic diagram depicting another phase of an embodiment of the methodology for orienteering with the orienteering tool of FIG. 1.

### DETAILED DESCRIPTION OF THE PREFERRED EMBODIMENT

With reference now to the drawings, the preferred embodiment of the orienteering tool is herein described. It should be noted that the articles “a”, “an”, and “the”, as used in this specification, include plural referents unless the content clearly dictates otherwise.

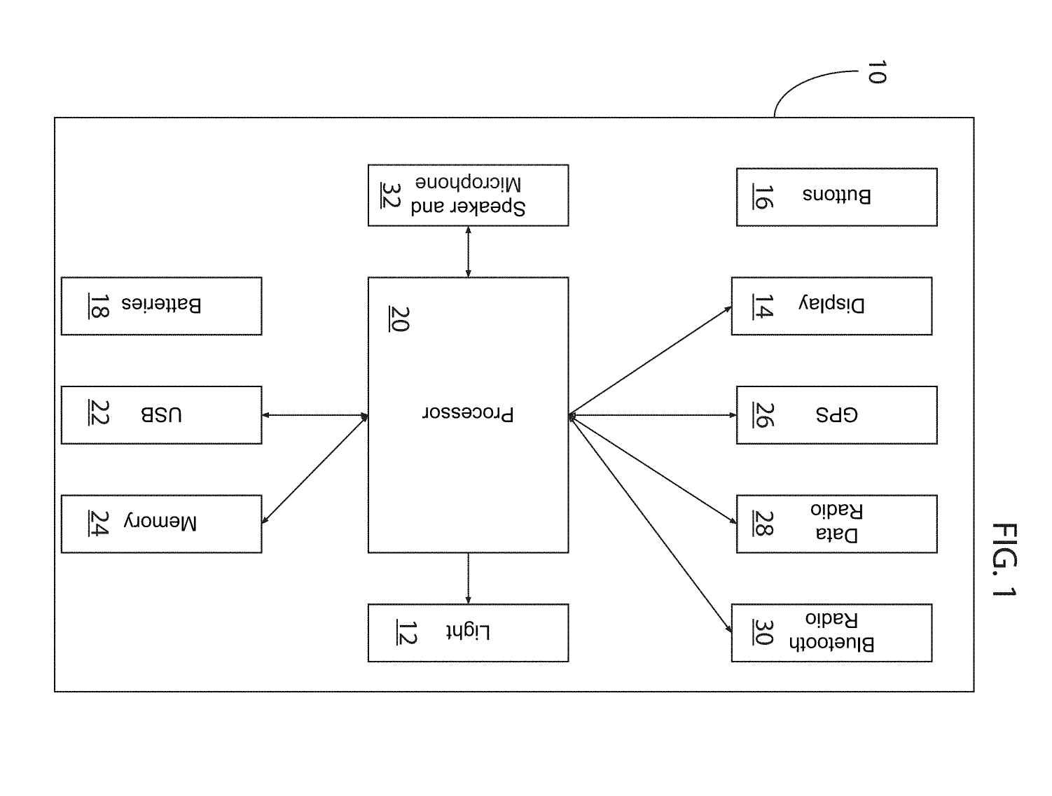

With reference to FIG. 1, a block diagram illustrates one possible arrangement of components for use in an orienteering tool according to the teachings of the present invention. Specifically, a casing 10 contains or provides a mounting for each component. A processor 20 provides as the functional direction while a memory/storage 24 contains any algorithms, databases or other useful information. Accessories required are a GPS and/or compass 26 and the output light 12. Output light 12 is used to illuminate a significant portion of the user's environment such that traveling through an otherwise darkened area is facilitated. An “output light” as used by this Specification should only be interpreted as including a directional light, flood-type light, or other light of significant strength such that the primary purpose of the output light is illumination of an area for traveling therein. As such, indicator lights which may be used to communicate status or other information are not to be considered as a type of “output light” as the term is used in this Application.

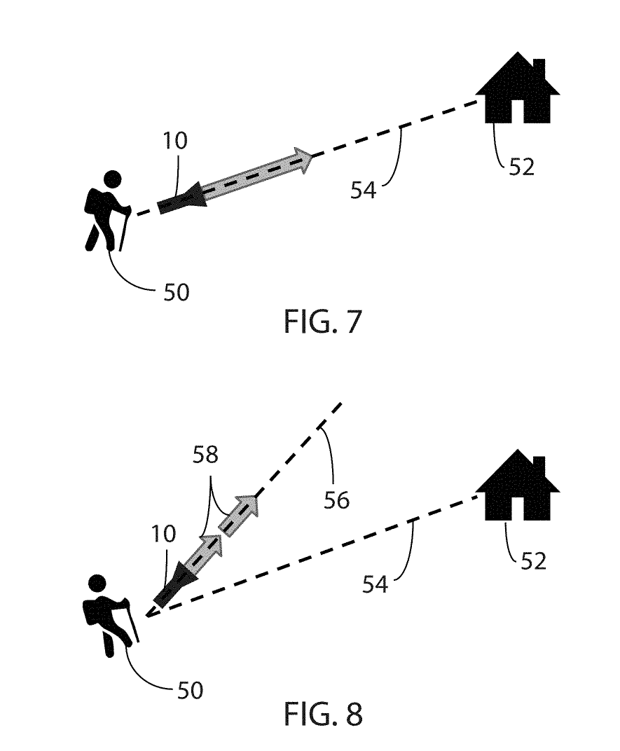

In use, the user 50 will utilize any input means provided, such as buttons 16, a touch screen, or through an external interface which may be connected by USB 22 or any other suitable connection means, to enter a desired location 52 into the unit 10. The processor will then utilize any data or algorithms within the unit memory 24 to calculate a course 54 to arrive at that location 52. It is entirely conceivable, of course, that the user may input an entire path of travel. The user 50 then travels, perhaps by walking, that course 54. The processor takes continued readings from the GPS sensor and compass to determine if the user is heading on the course (FIG. 7). The processor makes this calculation based on GPS data points measured as the user travels. If the user goes off course significantly 56 (FIG. 8) the processor 20 may then start an attention pattern 58 in the output light 12, such as blinking off every 5 seconds for half a second, to indicate to the user that he or she is of course. The pattern 58 may be any readily conceived by the designer. Different light sources, such as LEDs, allow for the use of creative and informative displays which may also indicate the direction a user must go to get back on course. However, it is sufficient in its most simple context for a flashing of a single light to get the user's attention. The directional tolerance for the user's course of travel may be set by the user or may be a default programmed into the processor 20. The functionality may also be temporarily or permanently disabled in the device.

While not central to the basic functionality of the invention, other tools may also be provided for increased functionality. FIG. 1 illustrates the addition of Bluetooth 30 and data radios 28 and a speaker and microphone 32. Providing a display 14 facilitates direct data input from the user but also may provide an auxiliary directional indicator. Other tools not illustrated, such as accelerometers, may also be utilized, and may even integrate with the basic functionality of the invention.

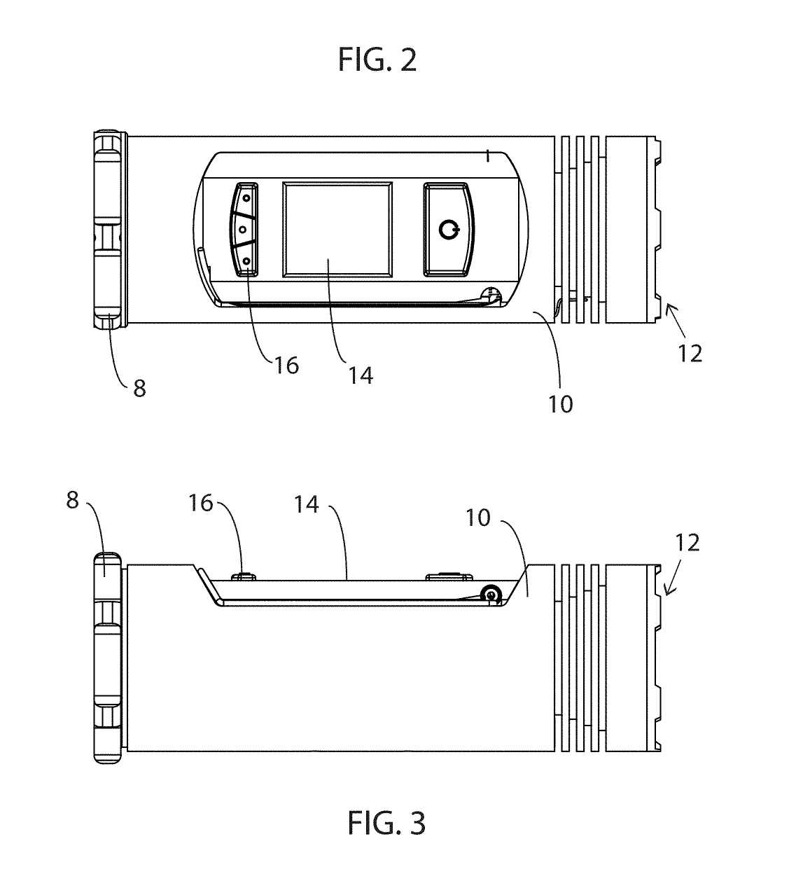

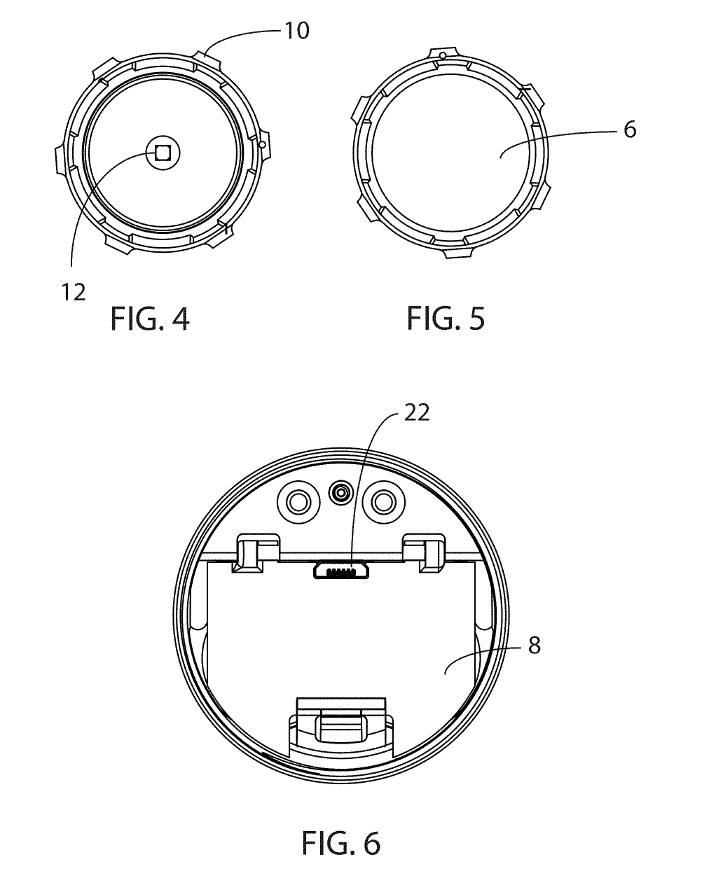

In its preferred embodiment, the orienteering tool should be contained within a handheld casing 10 (FIGS. 2-4). Buttons 16 and display 14 are easily mounted upon such a casing so as to allow user access. The conceptual design at this point is to make the unit similar in construction to a flashlight, which is to say cylindrical and handheld, as this provides a natural directional pointer and is readily usable. Casing 10 may be made of any material, such as a polymer, metal or composite, but it is preferred to be rugged and, to some degree weather and water resistant. An end cap 6 may be provided to protect any ports or recesses into the unit, such as USB port 22 and battery compartment 8, as shown in FIG. 6. Weatherproof and water resistant structuring of the end cap 8 is also understood to be preferred.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method of directional indication comprising:
a. providing an environmental illumination tool, said tool operatively connected to a processor, memory, and at least one directional tool;
b. using the environmental illumination tool to illuminate a direction of travel;
c. the at least one directional tool taking at least one reading concerning the direction of travel;
d. the processor determining if the direction of travel is consistent with a desired plan of travel;
e. if the direction of travel is not consistent with the desired plan of travel, then the processor imposing an attention pattern on the environmental illumination tool, until such time as the direction of travel and desired plan of travel are consistent with each other.

2. The method of claim 1, the at least one directional tool being selected from the set of directional tools consisting of: a GPS sensor unit and a compass.

3. The method of claim 1, the attention pattern also being a pattern indicative of a direction to make the direction of travel and desired plan of travel consistent with each other.

4. A tool for orienteering, the tool comprising:
a. A casing with input means and at least one display;
b. An environmental illumination light;
c. At least one directional tool; and
d. A processor and operative memory in operable communication with the input means, display, at least one directional tool, and environmental illumination light;
wherein the processor will receive directional data received from the at least one directional tool and compare said directional data to a desired course of travel and will utilize the environmental illumination light to generate an attention signal when the directional data diverges from the desired course of travel.

5. The tool for orienteering of claim 4, the at least one directional tool being selected from the set of directional tools consisting of: a GPS sensor unit and a compass.

6. The tool for orienteering of claim 4, the attention signal being a signal that also indicates a direction to make the directional data comport with the desired course of travel.

7. The tool for orienteering of claim 4, the display also serving as a directional indicator.

8. The tool for orienteering of claim 4, further comprising at least one additional tool.
